(19) United States
(12) Patent Application Publication
(10) Pub. No.: US 2025/0303395 A1
(43) Pub. Date: Oct. 2, 2025

(54) ASPHALTENE-BASED PHOTOCATALYST FOR THE DEGRADATION OF WATER POLLUTANTS AND METHODS OF PREPARATION THEREOF

(71) Applicant: KING FAHD UNIVERSITY OF PETROLEUM AND MINERALS, Dhahran (SA)

(72) Inventors: Mohammad Nahid SIDDIQUI, Dhahran (SA); Chanbasha BASHEER, Dhahran (SA)

(73) Assignee: KING FAHD UNIVERSITY OF PETROLEUM AND MINERALS, Dhahran (SA)

(21) Appl. No.: 18/624,792

(22) Filed: Apr. 2, 2024

(51) Int. Cl. B01J 23/18; B01J 21/18; B01J 35/30; B01J 35/39; B01J 35/45; B01J 35/51; B01J 35/61; B01J 35/64; B01J 37/02; B01J 37/08; B01J 37/12; C02F 1/32; C02F 1/461; C02F 1/467; C02F 101/12; C02F 101/16

(52) U.S. Cl. CPC B01J 23/18; B01J 21/18; B01J 35/39; B01J 35/394; B01J 35/45; B01J 35/51; B01J 35/615; B01J 35/617; B01J 35/643; B01J 35/647; B01J 35/651; B01J 37/0221; B01J 37/084; B01J 37/12; C02F 1/32; C02F 1/46109; C02F 1/4672; C02F 2001/46142; C02F 2101/12; C02F 2101/16; C02F 2305/08; C02F 2305/10

(57) ABSTRACT

A method of making a photocatalyst including heating asphaltenes to 400-600° C. under nitrogen for at least 30 minutes to form heated asphaltenes, mixing a hydroxide with the heated asphaltenes, and heating to a temperature of 700-900° C. under nitrogen for at least 1 hour to form reacted asphaltenes. Further, the method includes oxidizing the reacted asphaltenes with an oxidant to form a porous carbon. Finally, the method includes calcining the porous carbon with bismuth oxide and titanium dioxide at a temperature of 600-800° C. to form the photocatalyst.

### STATEMENT OF ACKNOWLEDGEMENT

Support provided by the deanship of scientific research at King Fahd University of Petroleum and Minerals (KFUPM) under DSR-DF191025 is gratefully acknowledged.

### BACKGROUND

### Technical Field

The present disclosure is directed toward a method of making a photocatalyst, particularly an asphaltene-based photocatalyst for the degradation of water pollutants.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Numerous harmful by-products produced during water disinfection procedures make it increasingly challenging for water utilities to provide safe drinking water. Unwanted disinfection byproducts (DBPs) can arise when chemicals like chlorine, ozone, and chloramine are used to disinfect water in the presence of suitable precursors like organic matter or some inorganics. These DBPs are various kinds of harmful chemical and inorganic compounds that are created when disinfectants interact with water's precursors. The majority of these substances are mutagenic and carcinogenic, therefore drinking water is currently monitored by many regulatory agencies. Trihalomethanes (THMs), haloacetic acids (HAAs), and haloacetonitriles (HAN) are notable regulated DBPs that are created during the chlorination of drinking water that contains considerable amounts of natural organic matter. The presence of some nitrogenous DBPs in treated water, such as nitrosamines, which are stronger and more harmful than the controlled DBPs, has become a cause for worry in addition to these regulated DBPs. The majority of nitrosamines that are present in treated water are formed when ozone or chloramine reacts with organic amine molecules in the water. Being a known human carcinogen and mutagen, N-nitrosamines like N-nitrosodimethylamine (NDMA) have been shown to cause health hazards even in trace amounts (ng/L) after repeated exposure. Given the danger that DBPs pose to humans, there has been an increase in research into ways to prevent their production during the water disinfection process or to speed up their removal once they have formed.

Several methods have been used to control the creation or removal of DBPs, some of which include membrane processes, electrochemical methods, advanced oxidation/reductions, and biodegradation. Due to its capacity to degrade DBPs to non-toxic intermediates or total mineralization, electrochemical techniques based on oxidation/reduction reactions generated via the application of electric current to electrodes have gained significant interest in recent years for DBP treatments. This kind of treatment often involves little to no chemical intervention, and it can be improved by utilizing electrodes that have been modified with catalysts to speed up the production of the oxidants and reductants needed for the degradation process. When compared to other treatment methods like the adsorption process, the electrochemical approach for the treatment of DBPs has only been applied in bench-scale laboratory experiments, despite the effectiveness. This restriction is brought about by the high expense of producing the catalyst electrodes, which are often made of expensive noble metals like platinum, pallidum, iridium, and silver.

While reduction of the pollutant can occur by accepting electrons from the electrode interface, oxidation of the pollutant can result via direct electron transfer from the pollutants to the electrode interface caused by the applied current. As an alternative, the electrodes may generate non-selective oxidants or reductants at the electrode interface or in the aqueous phase, which will interact with the target molecules to be degraded. In this situation, the method of treatment is known as indirect electrochemical treatment. Since it provides for quick oxidation or reduction of the target chemicals, indirect electrochemical oxidation/reduction is frequently preferred in water treatment for the removal of the majority of halogenated DBPs (THMs and HAAs). This method is frequently improved with the use of a catalyst or photocatalyst electrode, which starts the rapid synthesis of reductants or oxidants in the aqueous solution. Modified electrodes have the potential to provide an effective method for the degradation of these DBPs since they integrate electrochemical and photocatalytic approaches to degradation, which could lead to their use in a large-scale treatment procedure. The electrodes should include materials that are low-cost, such as recycled waste materials and inexpensive photocatalyst compounds like titanium dioxide (TiO₂) and bismuth oxide (Bi₂O₃).

Although several photocatalysts have been developed in the past for the photoelectrochemical degradation of organic pollutants, more efficient and cost-effective photocatalysts for this purpose still need to be fabricated and explored. It is one object of the present disclosure to provide an efficient photocatalyst including inexpensive materials.

### SUMMARY

In an exemplary embodiment, a method of making a photocatalyst is disclosed. The method includes heating asphaltenes to 400-600° C. under nitrogen for at least 30 minutes to form heated asphaltenes, mixing a hydroxide with the heated asphaltenes, and heating to a temperature of 700-900° C. under nitrogen for at least 1 hour to form reacted asphaltenes. Further, the method includes oxidizing the reacted asphaltenes with an oxidant to form a porous carbon. Finally, the method includes calcining the porous carbon with bismuth oxide and titanium dioxide at a temperature of 600-800° C. to form the photocatalyst. In some embodiments, the photocatalyst comprises 10-30 wt. % of the bismuth oxide and titanium dioxide total, based on a total weight of the photocatalyst. In some embodiments, particles of the bismuth oxide and titanium dioxide have a spherical shape with an average size of 50-100 nm, and the particles of the bismuth oxide and titanium dioxide are dispersed on a surface of the porous carbon to form the photocatalyst.

In some embodiments, the titanium dioxide has a rutile phase.

In some embodiments, the photocatalyst comprises 1-20 wt. % of the titanium dioxide and 1-20 wt. % of the bismuth oxide, based on a total weight of the photocatalyst.

In some embodiments, the particles of the bismuth oxide and the titanium dioxide are uniformly dispersed on the surface of the porous carbon.

In some embodiments, the porous carbon has an interconnected nanoflake morphology.

In some embodiments, the porous carbon has a BET surface area of 500-600 m²/g.

In some embodiments, the porous carbon has a pore volume of 1-50 nm.

In some embodiments, the porous carbon has an average pore diameter of 1-3 nm.

In some embodiments, the asphaltenes have an average molecular weight of 100-1,500 g/mol.

In some embodiments, the asphaltenes are extracted from crude oil.

In another exemplary embodiment, a photocatalyst is made by the aforementioned method.

In another exemplary embodiment, an electrode is described. The electrode comprises the photocatalyst and a substrate. In some embodiments, the particles of the photocatalyst are dispersed on the substrate to form the electrode.

In yet another exemplary embodiment, a method of degrading a compound in a solution is described. The method comprises contacting the electrode with the solution and simultaneously applying a voltage to the electrode and irradiating the solution with light. In some embodiments, upon applying the voltage and the irradiating, at least a portion of the compound is oxidized and degraded.

In some embodiments, the voltage is 5-50 V.

In some embodiments, the light has a wavelength of 200-500 nm.

In some embodiments, the applying the voltage and the irradiating is for 1-30 minutes.

In some embodiments, the compound is a nitrosamine.

In some embodiments, the compound is at least one of dichloroethylene and bromodichloromethane.

In some embodiments, the solution comprises 1 ppb to 10 ppm of the compound.

In some embodiments, at least 50% of the compound degrades following at least 10 minutes of applying the voltage and the irradiating.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a method flowchart for making a photocatalyst, according to certain embodiments.

FIG. 1B is a method flowchart for degrading a compound in an aqueous solution, according to certain embodiments.

FIG. 1C shows a schematic representation of the synthesis and application of doped porous carbon-based photocatalysts, according to certain embodiments.

FIG. 2 depicts the X-ray diffraction (XRD) pattern of the titanium dioxide doped porous carbon material (PCK—TiO₂) and titanium dioxide and bismuth oxide doped porous carbon material (PCK—TiO₂—Bi₂O₃), according to certain embodiments.

FIG. 3 depicts Raman spectra for PCK—TiO₂ and PCK—TiO₂—Bi₂O₃, according to certain embodiments.

FIG. 4A is a scanning electron microscopic (SEM) image of the PCK—TiO₂ sample, according to certain embodiments.

FIG. 4B is an SEM image of the PCK—TiO₂—Bi₂O₃ sample, according to certain embodiments.

FIG. 5A is a plot showing the effect of voltage on percentage degradation of dichloroethylene and bromodichloromethane with the PCK—TiO₂—Bi₂O₃ catalyst, according to certain embodiments.

FIG. 5B is a plot showing the effect of concentration on percentage degradation of dichloroethylene and bromodichloromethane with the PCK—TiO₂—Bi₂O₃ catalyst, according to certain embodiments.

FIG. 5C is a plot showing the effect of time on percentage degradation of dichloroethylene and bromodichloromethane with the PCK—TiO₂—Bi₂O₃ catalyst, according to certain embodiments.

FIG. 5D is a plot showing the effect of zero voltage on percentage degradation of dichloroethylene and bromodichloromethane with the PCK—TiO₂—Bi₂O₃ catalyst, according to certain embodiments.

FIG. 6A is a plot showing the effect of time on percentage degradation of dichloroethylene, for various concentrations with the PCK—TiO₂—Bi₂O₃ catalyst, according to certain embodiments.

FIG. 6B is a plot showing the effect of time on percentage degradation of bromodichloromethane with the PCK—TiO₂—Bi₂O₃ catalyst, for various concentrations, according to certain embodiments.

FIG. 7A is an SEM image of the porous carbon material (PCK) at a magnification of 5 μm, according to certain embodiments.

FIG. 7B is an SEM image of the PCK at a magnification of 50 μm, according to certain embodiments.

FIG. 7C is an SEM image of the PCK at a magnification of 30 μm, according to certain embodiments.

FIG. 7D is an SEM image of the PCK at a magnification of 10 μm, according to certain embodiments.

FIG. 7E is an SEM image of the PCK at a magnification of 2 μm, according to certain embodiments.

FIG. 8 is an XRD pattern of the PCK, according to certain embodiments.

FIG. 9 is a thermogravimetric analysis (TGA) spectrum of the PCK, according to certain embodiments.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown. Where a numerical limit or range is stated herein, the endpoints are included. Also, all values and subranges within a numerical limit or range are specifically included as if explicitly written out.

In the drawings, reference numerals designate identical or corresponding parts throughout the several views. Further, as used herein, the words “a,” “an,” and the like generally carry a meaning of “one or more,” unless stated otherwise. Furthermore, the terms “approximately,” “approximate,” “about,” and similar terms generally refer to ranges that include the identified value within a margin of 20%, 10%, or preferably 5%, and any values therebetween.

As used herein, the term “porosity” refers to a measure of the void or vacant spaces within a material.

As used herein, the terms “particle size” and “pore size” may be thought of as the lengths or longest dimensions of a particle and a pore opening, respectively.

As used herein, the term “sonication” refers to the process in which sound waves are used to agitate particles in a solution.

As used herein the term “de-ionized water” refers to the water that has the ions removed. As used herein, the term “calcination” refers to heating a compound to a high temperature, under a restricted supply of ambient oxygen. This is performed to remove impurities or volatile substances and to incur thermal decomposition.

As used herein, the term “oxidant” refers to a substance that gains or accepts electrons in a redox reaction.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%. The term “halo” or “halogen” includes fluoro, chloro, bromo and iodo.

The term “aryl” means a carbocyclic aromatic monocyclic group containing 6 carbon atoms which may be further fused to a second 5- or 6-membered carbocyclic group which may be aromatic, saturated or unsaturated. Aryl includes, but is not limited to, phenyl, anthracenyl, indanyl, 1-naphthyl, 2-naphthyl, and tetrahydronaphthyl. The fused aryls may be connected to another group either at a suitable position on the cycloalkyl/cycloalkenyl ring or the aromatic ring.

As used herein, the term “alkyl” unless otherwise specified refers to both branched and straight chain aliphatic (non-aromatic) hydrocarbons which may be primary, secondary, and/or tertiary hydrocarbons typically having 1 to 32 carbon atoms (e.g., C₁, C₂, C₃, C₄, C₅, C₆, C₇, C₈, C₉, C₁₀, C₁₁, C₁₂, C₁₃, C₁₄, etc.) and specifically includes, but is not limited to, saturated alkyl groups such as methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, tetradecyl, pentadecyl, hexadecyl, heptadecyl, octadecyl, nonadecyl, eicosyl, guerbet-type alkyl groups (e.g., 2-methylpentyl, 2-ethylhexyl, 2-proylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl), as well as unsaturated alkenyl and alkynyl variants such as vinyl, allyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, oleyl, linoleyl, and the like.

As used herein, the term “substituted” refers to at least one hydrogen atom that is replaced with a non-hydrogen group, provided that normal valencies are maintained and that the substitution results in a stable compound. When a substituent is noted as “optionally substituted”, the substituent(s) are selected from alkyl, halo (e.g., chloro, bromo, iodo, fluoro), hydroxyl, alkoxy, oxo, alkanoyl, aryloxy, alkanoyloxy, amino (—NH₂), alkylamino (—NHalkyl), cycloalkylamino (—NHcycloalkyl), arylamino (—NHaryl), arylalkylamino (—NHarylalkyl), disubstituted amino (e.g., in which the two amino substituents are selected from alkyl, aryl or arylalkyl, including substituted variants thereof, with specific mention being made to dimethylamino), alkanoylamino, aroylamino, arylalkanoylamino, thiol, alkylthio, arylthio, arylalkylthio, alkylthiono, arylthiono, arylalkylthiono, alkylsulfonyl, arylsulfonyl, arylalkylsulfonyl, sulfonamide (e.g., —SO₂NH₂), substituted sulfonamide (e.g., —SO₂NHalkyl, —SO₂NHaryl, —SO₂NHarylalkyl, or cases where there are two substituents on one nitrogen selected from alkyl, aryl, or alkylalkyl), nitro, cyano, carboxy, unsubstituted amide (i.e. —CONH₂), substituted amide (e.g., —CONHalkyl, —CONHaryl, —CONHarylalkyl or cases where there are two substituents on one nitrogen selected from alkyl, aryl, or alkylalkyl), alkoxycarbonyl, aryl, guanidine, heterocyclyl (e.g., pyridyl, furyl, morpholinyl, pyrrolidinyl, piperazinyl, indolyl, imidazolyl, thienyl, thiazolyl, pyrrolidyl, pyrimidyl, piperidinyl, homopiperazinyl), and mixtures thereof. The substituents may themselves be optionally substituted, and may be either unprotected, or protected as necessary, as known to those skilled in the art, for example, as taught in Greene, et al., “Protective Groups in Organic Synthesis”, John Wiley and Sons, Second Edition, 1991, hereby incorporated by reference in its entirety.

The present disclosure is intended to include all isotopes of a given compound or formula, unless otherwise noted, and all hydration states of a given compound or formula, unless otherwise noted or when heating a material.

Aspects of the present disclosure are directed toward the synthesis of asphaltene-based photocatalysts for the degradation of water pollutants. Porous carbon material (PCK) was obtained from asphaltenes, and this carbon was used as support for photocatalysts-titanium dioxide-doped porous carbon material (PCK—TiO₂) and titanium dioxide and bismuth oxide-doped porous carbon material (PCK—TiO₂—Bi₂O₃). The photocatalysts were cost-effective and very efficient for the degradation of dichloroethylene and bromodichloromethane.

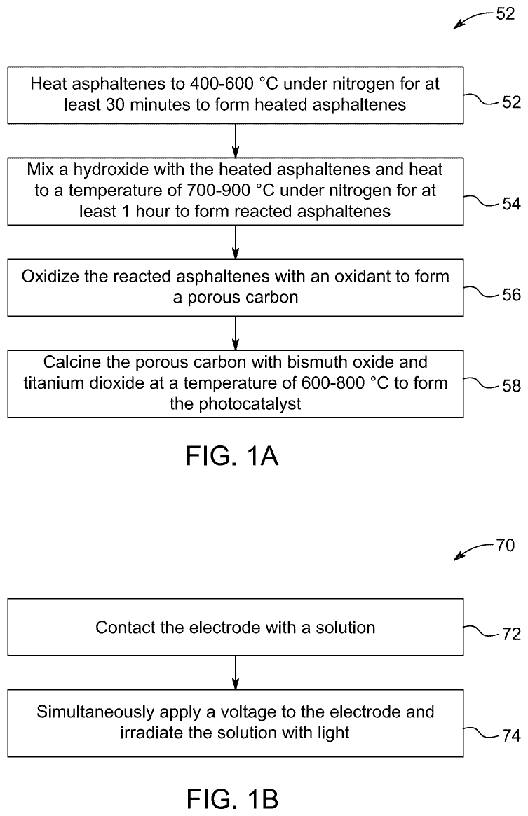

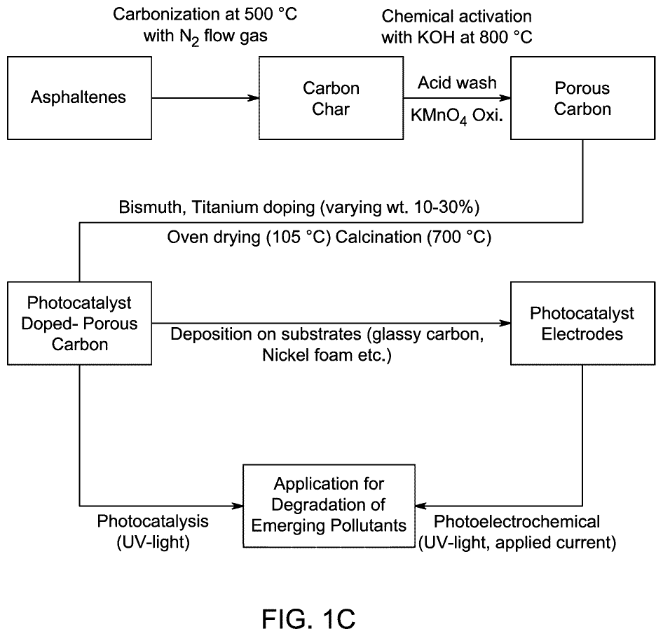

FIG. 1A illustrates a flow chart of a method 50 for making a photocatalyst. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes heating asphaltenes to 400-600° C., preferably 410-590° C., preferably 420-580° C., preferably 430-570° C., preferably 440-560° C., preferably 450-550° C., preferably 460-540° C., preferably 470-530° C., preferably 480-520° C., and preferably 490-510° C. under nitrogen for at least 30 minutes (min), preferably 45 min, preferably 60 min, preferably 75 min, preferably 90 min, preferably 105 min, and preferably 120 min to form heated asphaltenes. Asphaltenes are molecular substances found in crude oil, along with resins, aromatic hydrocarbons, and saturated carbons such as alkanes. The heating of asphaltenes can be done by using heating appliances such as hot plates, heating mantles ovens, microwaves, autoclaves, tapes, oil baths, salt baths, sand baths, air baths, hot-tube furnaces, and hot-air guns. In a preferred embodiment, the asphaltenes are heated to 500° C. under a nitrogen atmosphere for 1 h to form heated asphaltenes.

Asphaltene is obtained from crude oil, bitumen, or coal through separation with petroleum naphtha, n-pentane, and n-heptane. In a preferred embodiment, the asphaltenes are a waste product from an oil refinery, and therefore, the present method is a method of recycling and reducing waste. In a preferred embodiment, the asphaltenes are extracted from crude oil.

Asphaltenes are defined by solubility characteristics rather than chemical structures. In a preferred embodiment, the asphaltenes include carbon, hydrogen, nitrogen, oxygen, sulfur, vanadium and nickel. In a preferred embodiment, the asphaltenes include aromatic carbon rings. In some embodiments, the asphaltenes are functionalized with additional elements to improve catalytic properties, as described after steps 54 or 56.

In some embodiments, the asphaltenes have an average molecular weight of 100-1500 grams per mole (g/mol), preferably 200-1400 g/mol, preferably 300-1300 g/mol, preferably 400-1200 g/mol, preferably 500-1100 g/mol, preferably 600-1000 g/mol, preferably 700-900 g/mol. The C:H ratio is approximately 1-10 to 1-10, preferably 1:1, 1:2, 1:3, 1:4, 1:5, 1:6, 1:7, 1:8, 1:9, and 1:10 depending on the asphaltene source.

At step 54, the method 50 includes mixing a hydroxide with the heated asphaltenes and heating to a temperature of 700-900° C., preferably 710-890° C., preferably 720-880° C., preferably 730-870° C., preferably 740-860° C., preferably 750-850° C., preferably 760-840° C., preferably 770-830° C., preferably 780-820° C., and preferably 790-810° C. under nitrogen for at least 1 h, preferably 1.5 h, preferably 2 h, and preferably 2.5 h to form reacted asphaltenes. The hydroxide is selected from the group consisting of an alkaline earth metal hydroxide such as beryllium hydroxide (Be(OH)₂), magnesium hydroxide (Mg(OH)₂), strontium hydroxide (Sr(OH)₂), and calcium hydroxide (Ca(OH)₂) and an alkali metal hydroxide such as lithium hydroxide (LiOH), sodium hydroxide (NaOH), potassium hydroxide (KOH) and rubidium hydroxide (RbOH), and cesium hydroxide (CsOH). In a preferred embodiment, the hydroxide is KOH. The mixing may be carried out manually or with the help of a stirrer. In a preferred embodiment, the method includes mixing KOH with the heated asphaltenes and heating to a temperature of 800° C. under nitrogen for at least 1 h, preferably 1.5 h, preferably 2 h, and preferably 2.5 h to form reacted asphaltenes. The ratio of heated asphaltenes and KOH is from 1:1 to 1:6, preferably 1:2 to 1:5, and preferably 1:1 to 1:4. In a preferred embodiment, the ratio of heated asphaltenes and KOH is 1:4.

At step 56, the method 50 includes oxidizing the reacted asphaltenes with an oxidant to form a porous carbon. Suitable examples of oxidants include hydrogen peroxide, ozone, oxygen, potassium permanganate, potassium dichromate, chlorine, bromine, fluorine, and nitric acid. In a preferred embodiment, the oxidant is potassium permanganate (KMnO₄). In some embodiments, the asphaltenes are mixed with KMnO₄ for 2-7 h, preferably 3-6 h, and preferably 4-5 h. In a preferred embodiment, the asphaltenes are mixed with KMnO₄ for 5 h.

In some embodiments, the porous carbon may exist in various morphological shapes, such as rods, spheres, wires, crystals, rectangles, triangles, pentagons, hexagons, prisms, disks, cubes, ribbons, blocks, beads, toroids, discs, barrels, granules, whiskers, flakes, foils, powders, boxes, stars, tetrapods, belts, flowers, etc. and mixtures thereof. In a preferred embodiment, the porous carbon has an interconnected nanoflake morphology. The porous structure includes pores that may be micropores, mesopores, macropores, and/or a combination thereof.

In some embodiments, the porous carbon has a Brunauer-Emmett-Teller (BET) surface area of 500-600 square meters per gram (m²/g), preferably 500-600 m²/g, preferably 510-590 m²/g, preferably 520-580 m²/g, preferably 530-570 m²/g, preferably 540-560 m²/g. In a preferred embodiment, the porous carbon has a BET surface area of 539.12 m²/g.

In some embodiments, the porous carbon has a pore volume of 1-50 nm, preferably 2-48 nm, preferably 3-47 nm, preferably 4-46 nm, preferably 5-45 nm, preferably 6-44 nm, preferably 7-43 nm, preferably 8-42 nm, preferably 9-41 nm, preferably 10-40 nm, preferably 11-39 nm, preferably 12-38 nm, preferably 13-37 nm, preferably 14-36 nm, preferably 15-35 nm, preferably 16-34 nm, preferably 17-33 nm, preferably 18-32 nm, preferably 19-31 nm, preferably 20-30 nm, preferably 21-29 nm, preferably 22-28 nm, preferably 23-27 nm, and preferably 24-26 nm. In a preferred embodiment, the porous carbon has a pore volume of less than 40.31 nm.

In some embodiments, the porous carbon has an average pore diameter of 1-3 nm, preferably 1.5-2.5 nm, and preferably 1.75-2.25 nm. In a preferred embodiment, the porous carbon has an adsorption average pore diameter of 2.43492 nm. In a preferred embodiment, the porous carbon has a desorption average pore diameter of 2.47 nm.

In some embodiments, following steps 54 or 56, a surface of the asphaltene compounds includes hydroxide, carboxyl, and epoxide groups. In some embodiments, at least one of the hydroxide, carboxyl, and epoxide groups can be reacted and functionalized with additional elements or carbon groups to improve the electrocatalytic activity and sensitivity. In some embodiments, the functionalization includes reacting with a halogenation agent, such as but not limited to phosphorus tribromide (PBr₃) and thionyl chloride (SOCl₂). In such an embodiment, at least a portion of the carboxyl groups are converted to an acyl chloride or bromide group. In some embodiments, the acyl chloride or bromide group is maintained in the porous carbon or is subjected to an additional reaction. In some embodiments, the additional reaction includes reacting the acyl halide group with an alcohol to form an ester group (asphaltene-C(═O)—O—R¹) or reacting the acyl halide group with an amine to form an amide group (asphaltenes-C(═O)—NR¹R²), where R¹ and R² are the same or different and are selected from an optionally substituted alkyl or aryl group having 1-20 carbons, preferably 2-19 carbons, preferably 3-18 carbons, preferably 4-17 carbons, preferably 5-16 carbons, preferably 6-15 carbons, preferably 7-14 carbons, preferably 8-13 carbons, preferably 9-12 carbons, or preferably 10-11 carbons.

In an embodiment, the surface of the porous carbon is functionalized with a group to improve the compatibility with the pollutant, for example, when the pollutant is a nitrosamine, an ascorbic acid is functionalized on the porous carbon. The ascorbic acid reacts with the nitrosamine to form NO and dehydroascorbic acid.

In an alternative embodiment, the surface of the porous carbon is functionalized with a group to improve the compatibility with the catalyst particles that are added, specifically bismuth oxide (Bi₂O₃) and/or the titanium dioxide (TiO₂). For example, in some embodiments, the bismuth oxide and/or the titanium dioxide are in form of nanoparticles prior to the incorporation of the bismuth oxide and/or the titanium dioxide into the photocatalyst. In some embodiments, a surface of the bismuth oxide and/or the titanium dioxide nanoparticles are functionalized with at least one of an alkyl group having 1-20 carbons, preferably 2-19 carbons, preferably 3-18 carbons, preferably 4-17 carbons, preferably 5-16 carbons, preferably 6-15 carbons, preferably 7-14 carbons, preferably 8-13 carbons, preferably 9-12 carbons, or preferably 10-11 carbons, or a polyethylene glycol group having 1-20 carbons, preferably 2-19 carbons, preferably 3-18 carbons, preferably 4-17 carbons, preferably 5-16 carbons, preferably 6-15 carbons, preferably 7-14 carbons, preferably 8-13 carbons, preferably 9-12 carbons, or preferably 10-11 carbons. In combination, the porous carbon is functionalized with a matching group, for example, the porous carbon is functionalized with an alkyl group having 10 carbon atoms and in addition the bismuth oxide and/or the titanium dioxide nanoparticles are functionalized with an alkyl group having 10 carbon atoms. In a preferred embodiment, the functionalization improves the incorporation of the bismuth oxide and/or the titanium dioxide nanoparticles into the porous carbon.

At step 58, the method 50 includes calcining the porous carbon with bismuth oxide and titanium dioxide at a temperature of 600-800° C., preferably 610-790° C., preferably 620-780° C., preferably 630-770° C., preferably 640-760° C., preferably 650-750° C., preferably 660-740° C., preferably 670-730° C., preferably 680-720° C., and preferably 690-710° C. to form the photocatalyst. The calcination is carried out by heating it to a high temperature under a restricted supply of ambient oxygen. Typically, the calcination is carried out in a furnace, preferably equipped with a temperature control system, which may provide a heating rate of up to 50° C./min, preferably up to 40° C./min, preferably up to 30° C./min, preferably up to 20° C./min, preferably up to 10° C./min, preferably up to 5° C./min. In a preferred embodiment, the porous carbon is calcined with bismuth oxide and titanium dioxide at a temperature of 700° C.

In some embodiments, the photocatalyst includes about 10-30 wt. %, preferably 11-29 wt. %, preferably 12-28 wt. %, preferably 13-27 wt. %, preferably 14-26 wt. %, preferably 15-25 wt. %, preferably 16-24 wt. %, preferably 17-23 wt. %, preferably 18-22 wt. %, preferably 19-21 wt. % of the bismuth oxide and titanium dioxide total, based on the total weight of the photocatalyst.

In some embodiments, the photocatalyst comprises 1-20 wt. % of the titanium dioxide, preferably 2-19 wt. %, preferably 3-18 wt. %, preferably 4-17 wt. %, preferably 5-16 wt. %, preferably 6-15 wt. %, preferably 7-14 wt. %, preferably 8-13 wt. %, or preferably 9-12 wt. %, preferably 10-11 wt. %, of the titanium dioxide and 1-20 wt. % of the bismuth oxide, preferably 2-19 wt. %, preferably 3-18 wt. %, preferably 4-17 wt. %, preferably 5-16 wt. %, preferably 6-15 wt. %, preferably 7-14 wt. %, preferably 8-13 wt. %, or preferably 9-12 wt. %, preferably 10-11 wt. %, of the bismuth oxide, based on the total weight of the photocatalyst.

In some embodiments, the photocatalyst includes a same amount of the bismuth oxide and titanium dioxide. In some embodiments, the photocatalyst includes a higher amount of the bismuth oxide than the titanium dioxide. In some embodiments, the photocatalyst includes a higher amount of the titanium dioxide than the bismuth oxide.

In some embodiments, titanium dioxide may have a rutile phase, anatase phase, or brookite phase. In a preferred embodiment, titanium dioxide has a rutile phase. In some embodiments, particles of the bismuth oxide and the titanium dioxide are dispersed, preferably uniformly, on the surface of the porous carbon to form the photocatalyst. The particles cover at least 50%, preferably 55%, preferably 60%, preferably 65%, preferably 70%, preferably 75%, preferably 80%, preferably 85%, preferably 90%, and preferably >95% of the porous carbon.

In some embodiments, the particles of the bismuth oxide and titanium dioxide may exist in various morphological shapes, such as rods, spheres, wires, crystals, rectangles, triangles, pentagons, hexagons, prisms, disks, cubes, ribbons, blocks, beads, toroids, discs, barrels, granules, whiskers, flakes, foils, powders, boxes, stars, tetrapods, belts, flowers, etc. and mixtures thereof. In a preferred embodiment, the particles of the bismuth oxide and titanium dioxide have a spherical morphology. In a preferred embodiment, the particles of the bismuth oxide and titanium dioxide have an average diameter of 50-100 nm, preferably, 60-90 nm, or 70-80 nm.

In some embodiments, the photocatalyst does not include platinum, pallidum, iridium, gold and/or silver.

In another embodiment, an electrode is described. The electrode comprises the photocatalyst and a substrate. In some embodiments, the particles of the photocatalyst are dispersed on the substrate to form the electrode. The particles cover at least 50%, preferably 55%, preferably 60%, preferably 65%, preferably 70%, preferably 75%, preferably 80%, preferably 85%, preferably 90%, and preferably >95% of the substrate. In some embodiments, the photocatalyst may be dispersed on the surface of the substrate using one of the techniques like the drop-casting method, spray coating, spin coating, and dip coating. The substrate may be an aluminum substrate, a nickel substrate, a titanium substrate, a titanium alloy substrate, an aluminum alloy substrate, a magnesium alloy substrate, a nickel alloy substrate, a steel substrate, glassy carbon, copper, platinum, zinc, and tungsten substrate.

FIG. 1B illustrates a flow chart of a method 70 for degrading a compound in a solution. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes contacting the electrode with the solution. In some embodiments, the solution comprises 1 part per billion (ppb) to 10 parts per million (ppm) of the compounds, preferably 10 ppb to 1 ppm (1000 ppb), preferably 100-900 ppb, preferably 200-800 ppb, preferably 300-700 ppb, and preferably 400-600 ppb of the compound. In a preferred embodiment, the solution comprises 2 ppm of the compound. In some embodiments, the compound is a nitrosamine. In some embodiments, the compound is at least one of dichloroethylene and bromodichloromethane. In a preferred embodiment, the compound is dichloroethylene. In another preferred embodiment, the compound is bromodichloromethane.

In a preferred embodiment, the solution is an aqueous solution, where the water may be tap water, distilled water, bidistilled water, deionized water, deionized distilled water, reverse osmosis water, and/or some other water.

At step 74, the method 70 includes simultaneously applying a voltage to the electrode and irradiating the solution with light. In some embodiments, the applied voltage is in the range of 5-50 V, preferably 10-45 V, preferably 15-40 V, preferably 20-35 V, and preferably 25-30 V. In a preferred embodiment, the applied voltage is 50 V. In some embodiments, the light has a wavelength of 200-500 nm, preferably 225-475 nm, preferably 250-450 nm, preferably 275-425 nm, preferably 300-400 nm, preferably 325-475 nm, preferably 350-450 nm, and preferably 375-425 nm. The voltage application and irradiation are done for 1-30 minutes (min), 2-28 min, preferably 3-27 min, preferably 4-26 min, preferably 5-25 min, preferably 6-24 min, preferably 7-23 min, preferably 8-22 min, preferably 9-21 min, preferably 10-20 min, preferably 11-19 min, preferably 12-18 min, preferably 13-17 min, and preferably 14-16 min. In some embodiments, the voltage application and irradiation are done for up to 60 mins, preferably 50 mins, 40 mins, or 30 mins.

Upon applying the voltage and irradiating, at least a portion of the compound is oxidized and degraded. In some embodiments, at least 50%, preferably 55%, preferably 60%, preferably 65%, preferably 70%, preferably 75%, preferably 80%, preferably 85%, preferably 90%, preferably 95%, and preferably >99% of the compound degrades following at least 10 mins of applying the voltage and irradiating, preferably 15 mins, preferably 20 mins, preferably 25 mins, and preferably 30 mins of applying the voltage and irradiating. In a preferred embodiment, almost 100% of the compound degrades following 30 mins of applying the voltage and irradiation.

### EXAMPLES

The following examples demonstrate a method for making a photocatalyst. The examples are provided solely for illustration and are not to be construed as limitations of the present disclosure, as many variations thereof are possible without departing from the spirit and scope of the present disclosure.

### Example 1: Porous Carbon Preparation

10 grams (g) of asphaltenes were placed in a ceramic boat and were heated at 500 degrees Celsius (° C.) under a flow of N₂ for 1 hour (h). Then, the obtained samples were mixed with potassium hydroxide (KOH) in a ratio of 1:4 and heated at 800° C. under a flow of N₂ for 2 h. After the reaction completion, the sample was washed with acid and water to remove the base. Then, the sample was oxidized by mixing with 5 g of KMnO₄ for 5 h. Finally, the sample was washed and dried. The porous carbon used in this work was extracted from a petroleum matrix, and the components of the porous carbons differ based on the location of the extracted petroleum. The porous carbon is labeled throughout as PCK.

### Example 2: Synthesis of Photocatalyst-Doped Porous Carbon and Photocatalyst Electrode

The porous carbon was further doped by bismuth oxide (Bi₂O₃) and titanium dioxide (TiO₂) with varying weight percentages (10-30 wt. %). The embodiment described here includes 15 wt. % of the Bi₂O₃ and 15 wt. % of the TiO₂ relative to a total weight of the photocatalyst. Then, the porous carbon was calcined with bismuth oxide and titanium dioxide at a temperature of 700° C. to form the photocatalyst. The particles of the photocatalyst are dispersed on the substrate to form the electrode. FIG. 1C shows a schematic representation of an embodiment and the synthesis and application of doped porous carbon-based photocatalysts.

### Example 3: Degradation of Pollutants

To assess the degradation abilities of the photocatalyst, the photocatalysis of dichloroethylene and bromodichloromethane was carried out. Firstly, the concentration of the pollutant was varied. After the amount of pollutant was determined, the reaction was carried out for 30 min with and without applying voltage (5, 10, 20, and 50 V) to determine reaction parameters such as voltage and reaction time. In addition, during the photocatalytic experiments, the reaction was carried out while applying a voltage of 50V and irradiating the system with 425 nm light.

### Example 4: Morphological Characterization

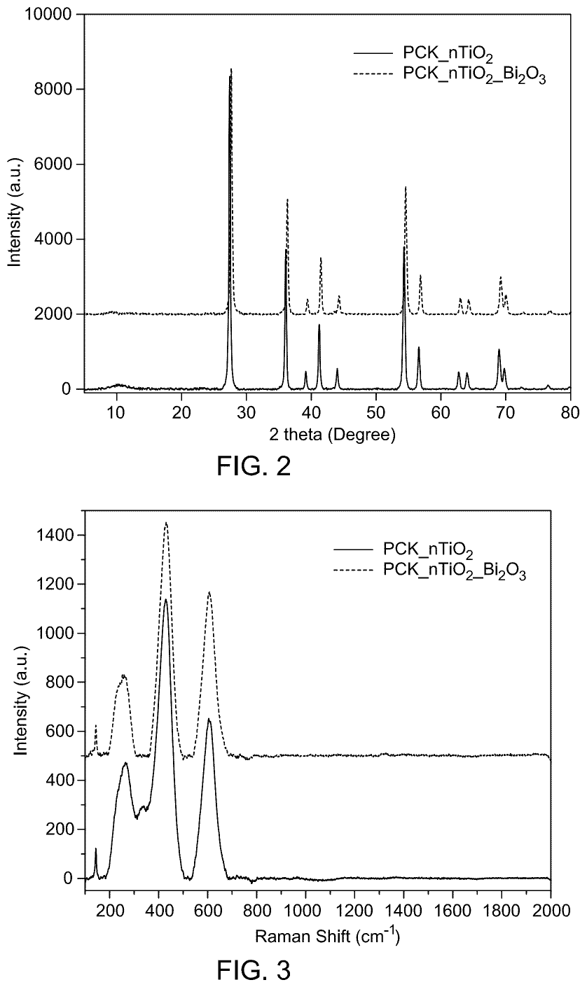

FIG. 2 depicts the X-ray diffraction (XRD) pattern of the titanium dioxide doped porous carbon material (PCK—TiO₂) and titanium dioxide and bismuth oxide doped porous carbon material (PCK—TiO₂—Bi₂O₃). The pattern for (PCK—TiO₂) showed reflections at 28°, 37°, 39°, 41°, 43°, 54°, 56°, and 62°, corresponding to the planes 110, 101, 200, 111, 210, 211 and 220 respectively, which show an excellent agreement with rutile phase of TiO₂. The sample PCK—TiO₂—Bi₂O₃ showed identical diffraction patterns due to the low loading of Bi₂O₃ (FIG. 2).

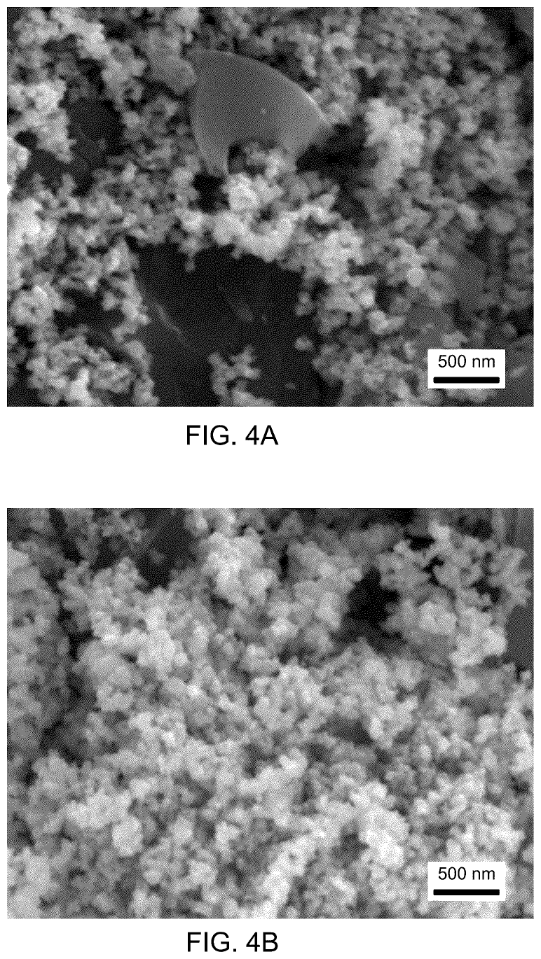

FIG. 3 depicts Raman spectra of PCK—TiO₂ and PCK—TiO₂—Bi₂O₃. Raman spectra reveal the vibrational peaks were recorded at 280, 430, and 650 cm-1 for the PCK—TiO₂ and PCK—TiO₂—Bi₂O₃ ascribed for the rutile TiO₂. The morphology of the prepared materials was studied using a scanning electron microscope (SEM) analysis. FIG. 4A and FIG. 4B shows SEM analysis of PCK—TiO₂ and PCK—TiO₂—Bi₂O₃, respectively. Both samples showed semi-spherical nanoparticles in size smaller than 100 nm. The small-sized nanoparticles enhance the degradation performance due to the high surface area of the catalyst. The small particles of the catalysts, Bi₂O₃ and TiO₂, were highly dispersed on the porous carbon support, which enhanced the catalysis process more effectively.

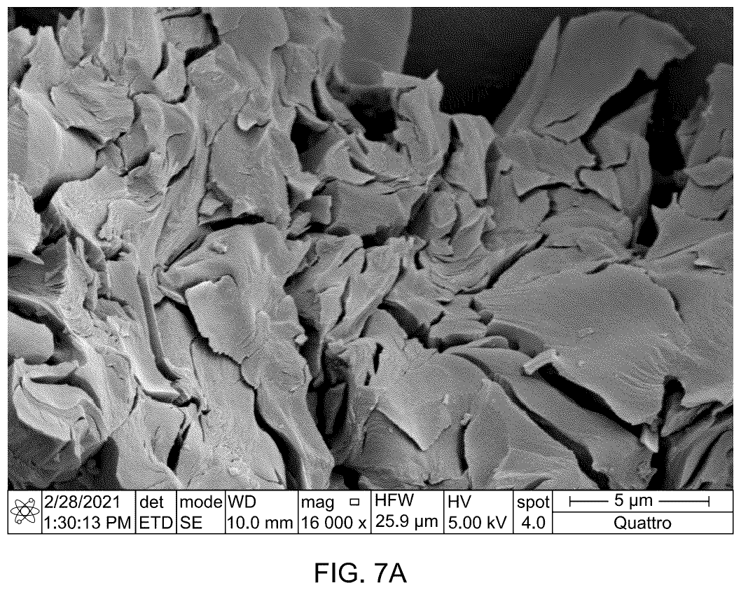

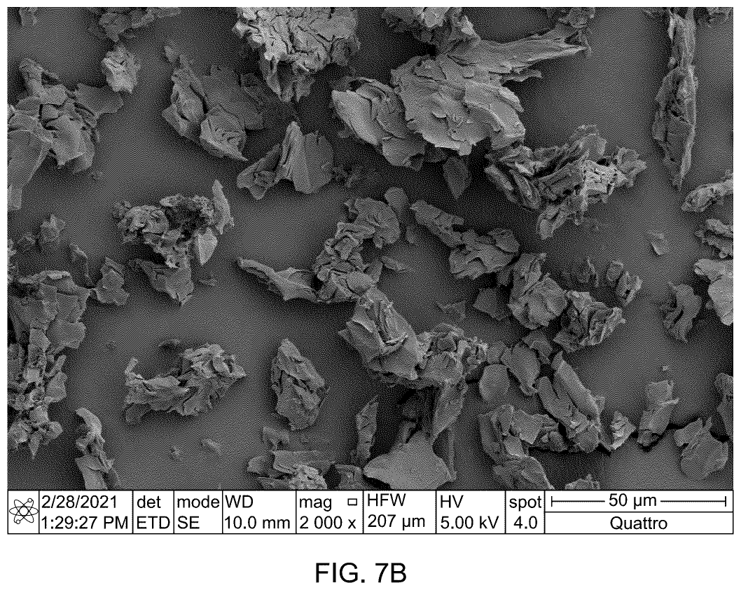

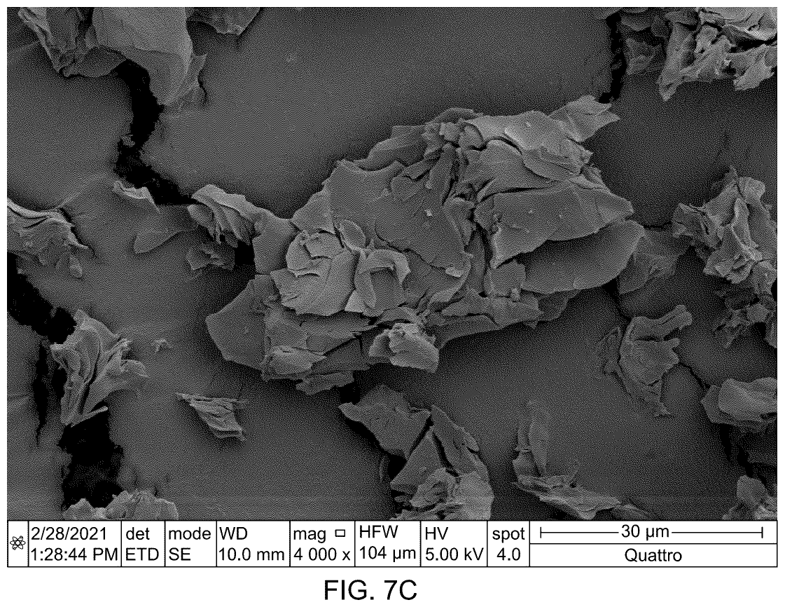

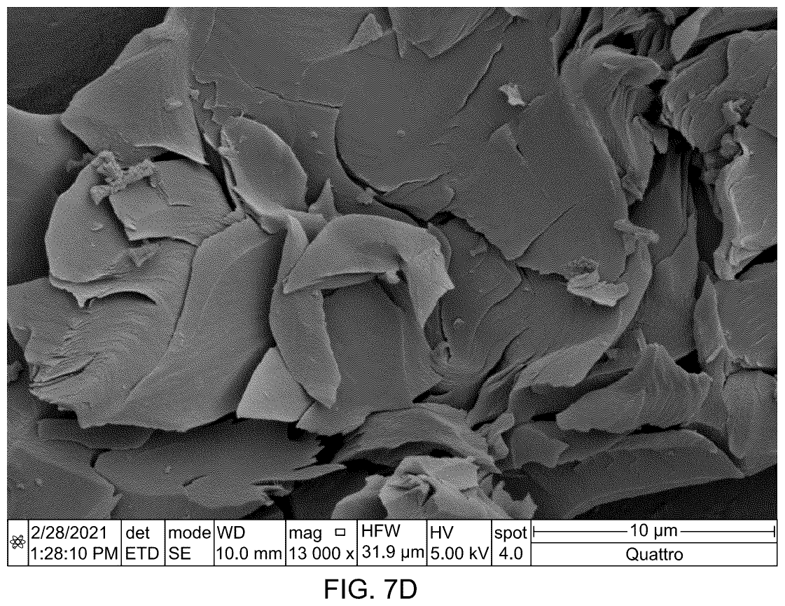

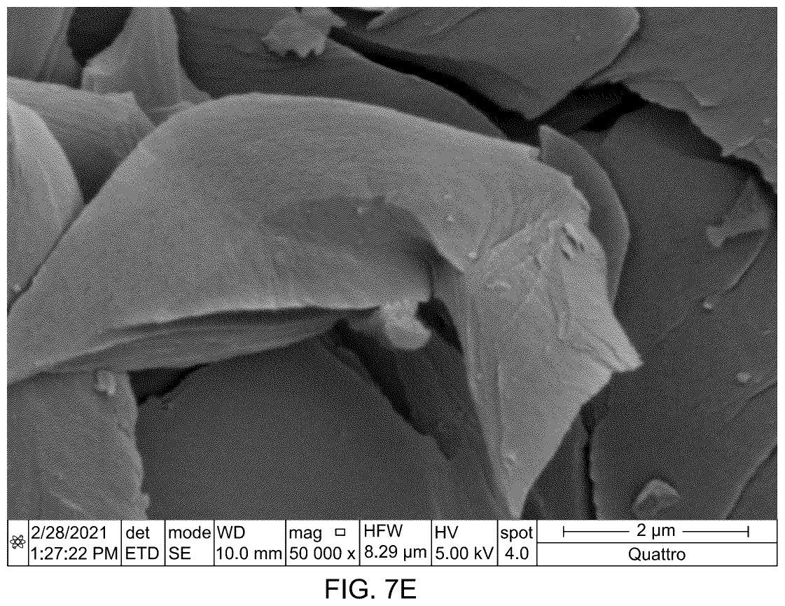

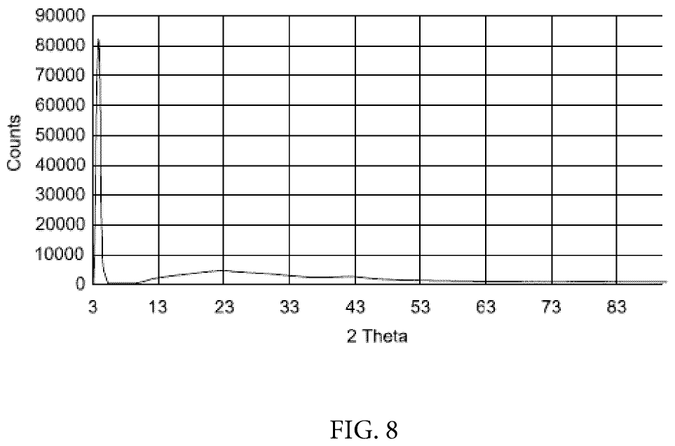

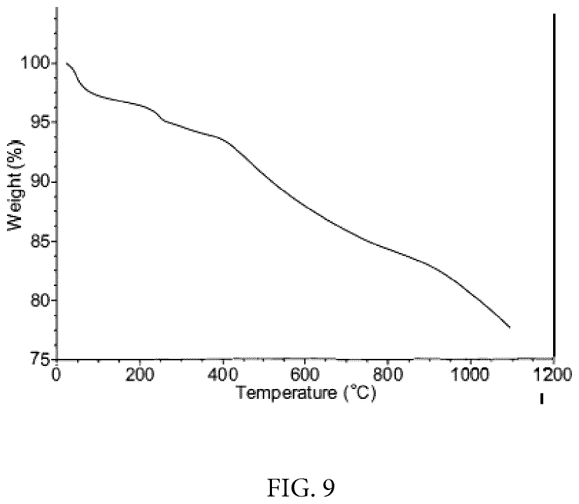

FIGS. 7A-7E depicts SEM images at different magnifications of the PCK prior to functionalization with the TiO₂ and the Bi₂O₃. The images show interconnected sheet like particles forming an extended porous structure. FIG. 8 depicts an XRD pattern of the PCK showing the amorphous nature of the porous carbon. FIG. 9 is a thermogravimetric analysis (TGA) spectrum of the PCK showing the gradual degradation of the PCK up to 1,100° C. The Brunauer-Emmett-Teller (BET) Surface Area of the PCK was found to be 539.1205 m²/g. The pore volume of the PCK was found to be less than 40.3122 nm. The pore size of the PCK was found to be the adsorption average pore diameter 2.43492 nm, and the desorption average pore diameter 2.47169 nm.

### Example 4: Degradation Performance

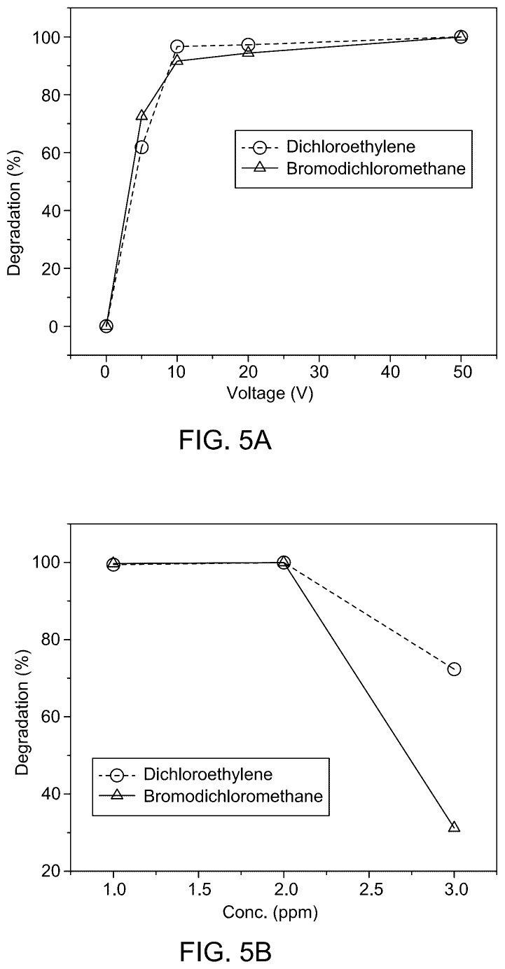

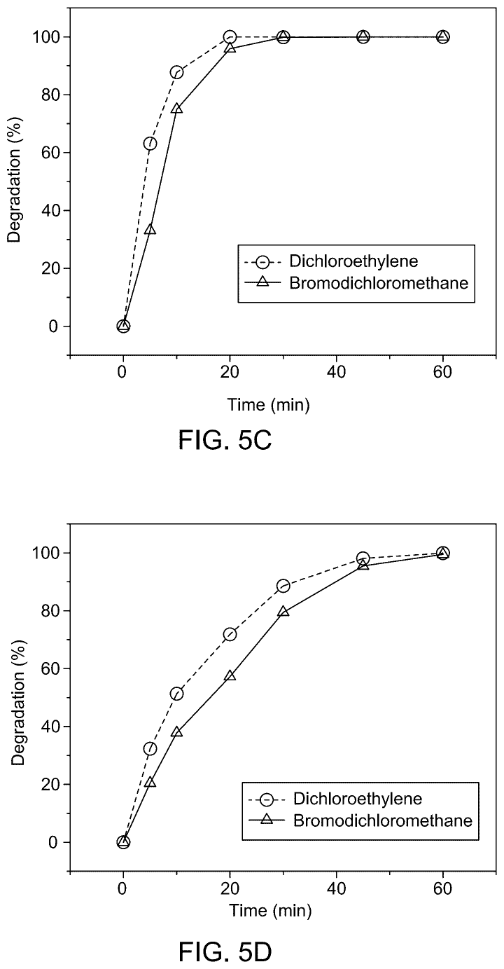

Several degradation parameters were tested, such as the voltage, time, and concentration of the two analytes, dichloroethylene and bromodichloromethane. FIG. 5A-5D shows the plots for variation of parameters of voltage, concentration, time, and zero voltage for the degradation of dichloroethylene and bromodichloromethane, respectively.

The reaction of 2 ppm of dichloroethylene and bromodichloromethane was carried out for 30 min without applying any voltage, and no significant degradation was observed. Then, a voltage of 5, 10, 20, and 50 V was applied at identical reaction conditions. It was observed that with increasing the voltage, the degradation percentage increased until 50 V, where 100% degradation was obtained (FIG. 5A).

Three concentrations were investigated to find the reactant's initial concentrations (1, 2, and 3 ppm) (FIG. 5B). The reaction took place at 50 V for 30 min reaction time. The concentration of 2 ppm showed 100% degradation.

The reaction time was also studied, and the reaction was carried out at 50 V with a concentration of reactants at 2 ppm at different periods (5, 10, 20, 30, 40, 50, and 60 min). Initially, the degradation efficiency increased with time until it reached a plateau (100%) at 30 min (FIG. 5C).

The effect of zero voltage was studied, i.e., the potential of the PCK—TiO₂—Bi₂O₃ catalyst as a photocatalyst and not an electrocatalyst as in the previous experiments. After 60 minutes the 100% of the dichloroethylene and bromodichloromethane is degraded and shown in FIG. 5D.

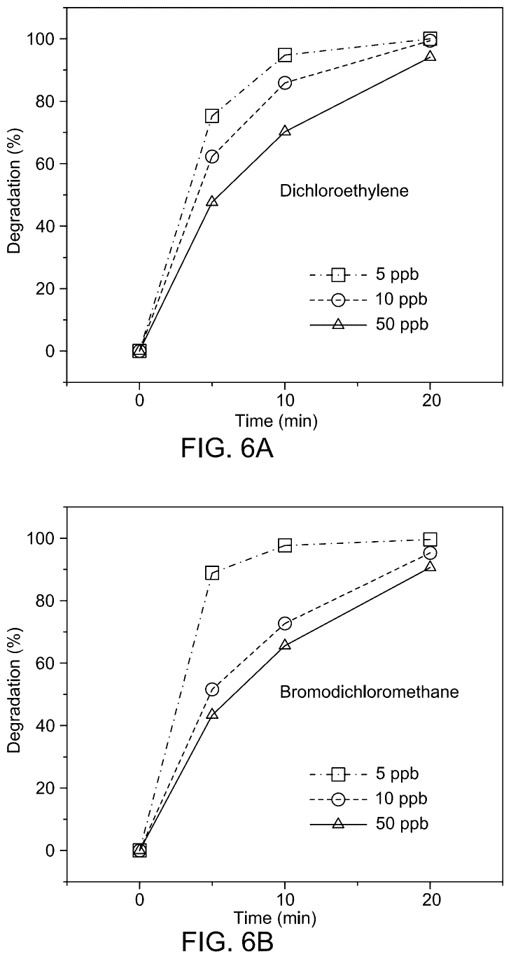

To test the efficiency and sensitivity of the method, the degradation efficiency of trace concentration (5, 10, and 50 ppb) was investigated. FIG. 6A is a plot showing the effect of time on percentage degradation for various concentrations of dichloroethylene, and FIG. 6B is a plot showing the effect of time on percentage degradation for various concentrations of bromodichloromethane, for various concentrations. In both FIG. 6A and FIG. 6B it can be observed that the percentage degradation was found to be concentration dependent. More than 90% of dichloroethylene and bromodichloromethane were found to be degraded within 20 mins at lower concentrations (5 ppb), and more than 80% of dichloroethylene and bromodichloromethane were found to be degraded within 20 mins at higher concentrations (50 ppb) with the photocatalyst of the present disclosure.

To summarize, porous carbon was synthesized from a cost-effective source (asphaltenes) and was used as support for photocatalysts (TiO₂, TiO₂—Bi₂₀₃). PCK—TiO₂—Bi₂O₃ was characterized using several characterization techniques. The PCK—TiO₂—Bi₂O₃ prepared by the method of present disclosure demonstrated an excellent degradation efficiency for organic pollutants (dichloroethylene and bromodichloromethane) using 50 V with 2 ppm pollutant concentration for 30 min reaction time.

Numerous modifications and variations of the present disclosure are possible in light of the above teachings. Therefore, it is to be understood that within the scope of the appended claims, the invention may be practiced other than as specifically described herein.

1: A method of making a photocatalyst, comprising:
heating asphaltenes to 400-600° C. under nitrogen for at least 30 minutes to form heated asphaltenes;
mixing a hydroxide with the heated asphaltenes and heating to a temperature of 700-900° C. under nitrogen for at least 1 hour to form reacted asphaltenes;
oxidizing the reacted asphaltenes with an oxidant to form a porous carbon; and
calcining the porous carbon with bismuth oxide and titanium dioxide at a temperature of 600-800° C. to form the photocatalyst,
wherein the photocatalyst comprises 10-30 wt. % of the bismuth oxide and titanium dioxide, based on a total weight of the photocatalyst,
wherein particles of the bismuth oxide and titanium dioxide have a spherical shape with an average size of 50-100 nm, and
wherein the particles of the bismuth oxide and titanium dioxide are dispersed on a surface of the porous carbon to form the photocatalyst.

2: The method of claim 1, wherein the titanium dioxide has a rutile phase.

3: The method of claim 1, wherein the photocatalyst comprises 1-20 wt. % of the titanium dioxide and 1-20 wt. % of the bismuth oxide, based on a total weight of the photocatalyst.

4: The method of claim 1, wherein the particles of the bismuth oxide and the titanium dioxide are uniformly dispersed on the surface of the porous carbon.

5: The method of claim 1, wherein the porous carbon has an interconnected nanoflake morphology.

6: The method of claim 1, wherein the porous carbon has a BET surface area of 500-600 m²/g.

7: The method of claim 1, wherein the porous carbon has a pore volume of 1-50 nm.

8: The method of claim 1, wherein the porous carbon has an average pore diameter of 1-3 nm.

9: The method of claim 1, wherein the asphaltenes have an average molecular weight of 100-1,500 g/mol.

10: The method of claim 1, wherein the asphaltenes are extracted from crude oil.

11: A photocatalyst made by the method of claim 1.

12: An electrode, comprising:
the photocatalyst of claim 11, and
a substrate,
wherein particles of the photocatalyst are dispersed on the substrate to form the electrode.

13: A method of degrading a compound in a solution, comprising:
contacting the electrode of claim 12 with the solution; and
simultaneously applying a voltage to the electrode and irradiating the solution with light, wherein upon the applying the voltage and the irradiating, at least a portion of the compound is oxidized and degrades.

14: The method of claim 13, wherein the voltage is 5-50 V.

15: The method of claim 13, wherein the light has a wavelength of 200-500 nm.

16: The method of claim 13, wherein the applying the voltage and the irradiating is for 1-30 minutes.

17: The method of claim 13, wherein the compound is a nitrosamine.

18: The method of claim 13, wherein the compound is at least one of dichloroethylene and bromodichloromethane.

19: The method of claim 13, wherein the solution comprises 1 ppb to 10 ppm of the compound.

20: The method of claim 13, wherein at least 50% of the compound degrades following at least 10 minutes of applying the voltage and the irradiating.
